(19) United States
(12) Patent Application Publication
(10) Pub. No.: US 2026/0100153 A1
(43) Pub. Date: Apr. 9, 2026

(54) TUNABLE LIGHT EMISSIONS FOR CIRCADIAN MODERATION

(71) Applicant: KORRUS, INC., Los Angeles, CA (US)

(72) Inventors: Benjamin HARRISON, Los Angeles, CA (US); Paul Kenneth PICKARD, Los Angeles, CA (US); William COULTER, Los Angeles, CA (US); Sina AFSHARI, Los Angeles, CA (US)

(21) Appl. No.: 19/417,990

(22) Filed: Dec. 12, 2025

Related U.S. Application Data
(63) Continuation of application No. PCT/US24/33726, filed on Jun. 13, 2024.
(60) Provisional application No. 63/472,638, filed on Jun. 13, 2023.

(51) Int. Cl. G09G 3/20; G09G 3/30

(52) U.S. Cl. CPC G09G 3/2003; G09G 3/30; G09G 2320/0666; G09G 2354/00; G09G 2380/08

(57) ABSTRACT

A display comprising: (a) a plurality of pixels, each pixel comprising at least one tunable light emitter to emit tuned light in at least two modes, a low equivalent melanopic lux (EML) mode and a high EML mode, wherein said tuned light in either said low EML mode or said high EML mode spans substantially the visible light range; and (b) circuitry to drive said at least one tunable light emitter in said at least two modes.

### REFERENCE TO RELATED APPLICATION

The present application claims the benefit of U.S. Provisional Patent Application 63/472,638, filed Jun. 13, 2023; the entire disclosures of each are hereby incorporated herein by reference.

### FIELD OF INVENTION

The present invention is directed generally to tunable emissions, and, more specifically, to tunable pixels in a display to moderate circadian stimulation.

### BACKGROUND

Circadian Rhythms are natural, internal processes that regulate the sleep-wake cycle and repeat roughly every 24 hours. They are influenced by external cues, especially light, which affects the production of melatonin, a hormone that promotes sleep. Exposure to light, especially blue light (wavelengths around 460-480 nm), suppresses melatonin production, promoting alertness and wakefulness. Conversely, the absence of blue light or exposure to warmer light (with more red and less blue content) in the evening promotes melatonin production, aiding sleep.

As used herein, the term “circadian-stimulating energy characteristics” refers to any characteristics of a spectral power distribution that may have biological effects on a subject. Circadian-stimulating energy characteristics may be described in various terms, including, for example, circadian-stimulating energy (CSE), circadian stimulation (CS), Equivalent Melanopic Lux (EML), and M/P ratio. Of particular interest herein are EML and M/P ratio. EML provides a measure of photoreceptive input to circadian and neurophysiological light responses in humans. The M/P ratio compares the melanopic (ipRGC) potential to the light source's ability to produce light for daytime detail vision (photopic vision).

Displays are a significant source of light for people. Today's displays use primaries with fixed emission spectra to produce the colors contained within the gamut. Most displays use three primaries, namely red, green, and blue. Thus, the blue/green light has a significant effect on circadian stimulation.

Applicant understands the need to not only improve the resolution of displays, but also to control/moderate their circadian effects. The present invention fulfills this need among others.

### SUMMARY OF INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

One aspect of the present invention is a display. In one embodiment, the display comprises (a) a plurality of pixels, each pixel comprising at least one tunable light emitter to emit tuned light in at least two modes, a low equivalent melanopic lux (EML) mode and a high EML mode, wherein the tuned light in either the low EML mode or the high EML mode spans substantially the visible light range; and (b) circuitry to drive the at least one tunable light emitter in the at least two modes. In one particular embodiment, the tuned light in the high EML mode and the tuned light in the low EML mode are metameric spectra.

### SUMMARY OF FIGURES

FIGS. 1A and 1B show a tunable light emitter emitting variable double peaks.

FIG. 2 shows an example color (white) may be produced by a range of wavelength pairs. These metamers may have considerably different properties, for example the 490 nm-600 nm pair will have a much higher m/p ratio than the 425 nm-575 nm pair.

FIG. 3 shows a three primary, tunable system.

FIG. 4 shows the three primary, tunable system of FIG. 3 in a low EML mode.

FIG. 5 shows the three primary, tunable system of FIG. 3 in a high EML mode.

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

One aspect of the present invention is display. In one embodiment, the display comprises (a) a plurality of pixels, each pixel comprising at least one tunable light emitter to emit tuned light in at least two modes, a low equivalent melanopic lux (EML) mode and a high EML mode, wherein the tuned light in either the low EML mode or the high EML mode spans substantially the visible light range; and (b) circuitry to drive the at least one tunable light emitter in the at least two modes. Each of these elements is described in greater detail below along with selected alternative embodiments.

In one embodiment, the tuned light in the high EML mode and the tuned light in the low EML mode are metameric spectrums. Metameric spectra refer to different light spectra that appear identical to human vision under certain conditions despite having different spectral power distributions. This phenomenon is known as metamerism. Specifically, every light source has a spectral power distribution (SPD), which describes the intensity of light at each wavelength. Different light sources can have different SPDs. Human vision perceives color through three types of photoreceptor cells (cones) in the retina, each sensitive to different ranges of wavelengths (roughly corresponding to red, green, and blue). The brain processes the signals from these cones to produce the perception of color. Two light sources with different SPDs can stimulate the three types of cones in the same way, resulting in the same color perception. When this happens, the light sources are called metamers. Despite looking identical to human eyes, the underlying spectral compositions of these light sources are different.

Applicant herein discloses using metameric spectrums to moderate circadian responses. For example, in one embodiment, for morning and afternoon, the lighting system uses a spectrum rich in blue light but balanced to appear as neutral white light to the human eye. This spectrum helps keep people alert and focused. For evening, the lighting shifts to a metameric spectrum with less blue light content but still appears as a pleasant, warm white light. This helps people wind down and prepares their bodies for sleep later in the evening.

As discussed above, an important aspect of the present invention is a light system having a low EML mode. In one embodiment, the low EML mode reduces blue light in the emitted light. In one embodiment, the emitted light has an overall SPD power and a blue light SPD power between 440 and 495 nm, wherein the blue SPD power is no greater than at least 5%, or 3%, or 2%, or 1% of the overall SPD power. Rather than blue light, in one embodiment, the present invention compensates for the blue light with violet light. In one embodiment, the emitted light has an overall SPD power and a violet SPD power between 380 and 420 nm, wherein the violet SPD power is at least 2%, or 3%, or 4%, or 5% of the overall SPD power.

The reduction in the blue component of light has a positive effect in reducing circadian stimulation. In the low EML mode, the M/P ratio is no greater than 1 below 6000K, or no greater than 0.8 below 4000K, or no greater than 0.6 below 3000K.

In one embodiment, the lighting system of the present disclosure also has a high EML mode. In one embodiment, the emitted light has an overall SPD power and a blue light SPD power between 440 and 495 nm, wherein the blue SPD power is no less than 5%, or 10%, or 20% of the overall SPD power. In one embodiment, the emitted light in the high EML mode has an M/P ratio is no less than 0.8 above 4000K, and no less than 1 above 5000K.

In one embodiment, the tuned light in the high EML mode and the tuned light in the low EML mode have an EML ratio of no less than 2:1, or 3:1, or 4:1 or 5:1, or 6:1, or 7:1, or 8:1, or 9:1, or 10:1. In one embodiment, the tuned light in the low EML mode has an EML no greater than 180, or no greater than 170, or no greater than 160, or no greater than 150. In one embodiment, the circadian stimulus (CS) is the circadian stimulus is greater than 0.3/day in the high EML mode, and less than 0.1/day in the low EML mode.

In one embodiment, the system has in intermediate EML mode which would be suitable for afternoon exposure, for example. In one embodiment, an EML ratio of the intermediate EML mode of the low EML mode is no less than 1.5:1, or 2:1, or 3:1. In one embodiment the CS for the intermediate EML mode is less than 0.2.

In one embodiment, either a controller or an external controller (or both) uses machine learning algorithms or other data analysis techniques to determine the user's current body clock time. For example, it might infer that the user is in their “daytime” phase if they have been active and exposed to bright light, while it might infer that they are in their “nighttime”phase if they have been inactive and in dim light.

Three different embodiments of a tunable pixel having different EML modes are considered in this disclosure: (1) Configurable spectrum—a single pixel or sub-pixel is configured to produce any spectral power distribution; (2) Widely-tunable single peak—a single pixel or sub-pixel with the ability to emit light with any peak wavelength with an approximately constant associated emission profile, e.g., gaussian with some full-width, half-max; and (3) Constrained single peak—same as single peak but constrained to a wavelength band within the visible spectrum, e.g., 400-500 nm (this may be caused by material property constraints).

Accordingly, in one embodiment, the at least one tunable light emitter comprises just one tunable light emitter configured to emit a configurable spectrum. In this case, a pixel is formed with a single emitter. Since the primary constraint of a pixel is its chromaticity and luminance without regard for color rendering index or other quality metrics, there is considerable latitude when it comes to SPD design. Accordingly, the emission spectrum can be optimized for other metrics, including, for example:
Luminous efficacy
Maximum m/p ratio
Minimum m/p ratio
Maximum blue %
Minimum blue %
Minimize interobserver variability.

The spectrum may also be optimized for combinations (linear or non-linear) of these. A constrained optimization is also possible in which, for example, a certain minimum luminous efficacy is specified while another parameter is optimized.

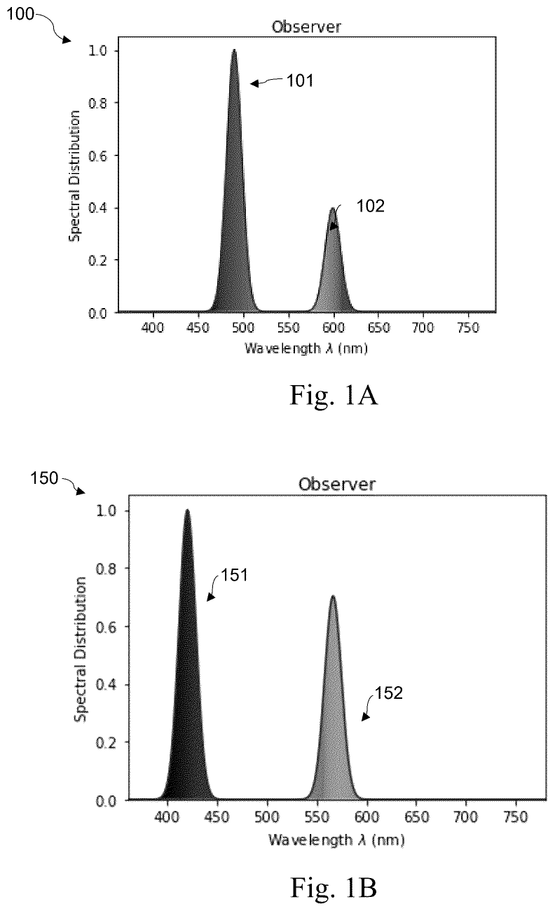

In one embodiment, the just one tunable light emitter emits two peaks, each of the two peaks being tunable. With a pair of variable peaks, it is possible to produce any color. This is achieved by selecting a pair of peaks with chromaticities such that their connecting line intersects the target color and then adjust the power of the peaks to hit the target. For example, the spectrum 100 has two peaks 101, 102 as shown FIG. 1A, which can be powered to combine to form the targeted white point of sRGB (0.3127, 0.3290). The peaks 101, 102 are at 490 nm and 600 nm.

Moreover, two sets of variable peaks can not only produce any color but also produce metameric spectrums of high and low eml light. For example, referring to FIG. 1B, a low EML mode spectrum 150 has two peaks 151, 152 which may also be combined to form the same targeted white point of sRGB (0.3127, 0.3290). Here, the peaks 151, 152 are at 420 nm and 567 nm. Each of the spectra in FIGS. 1A and 1B have a corresponding spectral power density (SPD) with an m/p ratio. The spectrum of FIG. 1A has an m/p ratio of approximately 2.5 which is relatively high EML light, and the spectrum of FIG. 1B has an m/p of approximately 0.37, which is relatively low EML light. Assuming an image is displayed that contains an equal representation of all of the colors available in sRGB, then there is an approximate maximum m/p ratio of 2.6 and minimum of 0.53. This approach allows for higher highs and lower lows of the m/p ratios, compared to a fixes emission system, while covering substantially the entire gamut.

In one embodiment, the two peaks are tunable over at least a substantial portion of the visible light spectrum—e.g., the substantial portion of the visible light spectrum is from 440 to 630 nm, or from 420 to 640 nm, or from 400 to 700 nm. In such an embodiment, just one tunable light emitter forms a pixel.

With light transmitters having a single peak, only single colors can be produced. However, with a pair of single peak emitters, any color can be produced. Further, a color may be produced in different ways using Metameric spectra as discussed above. See, e.g. PCT/US2021/012738, which discloses examples of dual peak, white metamers with high and low m/p ratios. Note that the multiple peaks from a single emitter analysis can equally be applied to discrete single peak emitters working together as a ‘pixel.’

Accordingly, in one embodiment, the at least one tunable light emitter comprising two tunable light emitters, each of the two tunable light emitters emitting a tunable peak. In one embodiment, each tunable peak is tunable over at least a substantial portion of the visible light spectrum. In one embodiment, the substantial portion of the visible light spectrum is from 440 to 630 nm, or from 420 to 640 nm, or from 400 to 700 nm.

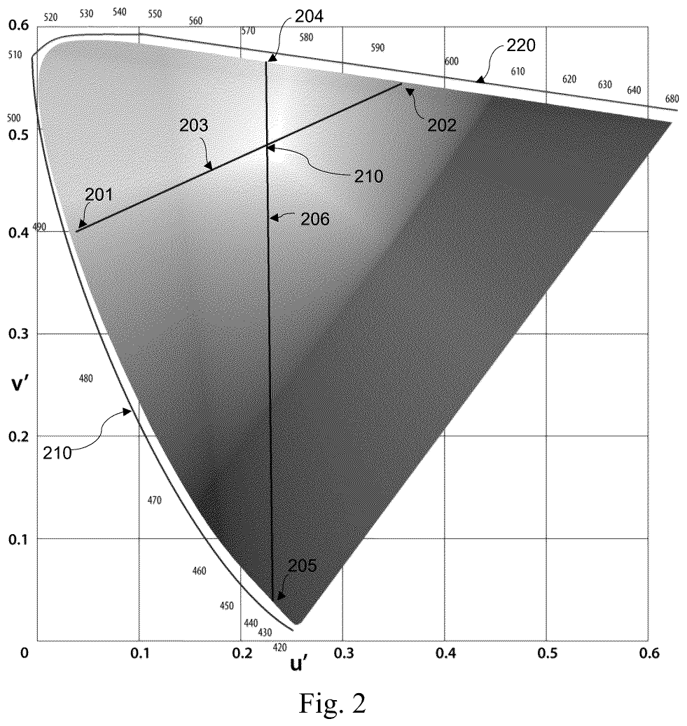

In one embodiment, each of the tunable light emitter is tunable over different portions of the visible light spectrum. If a tunable emission technology exists but is constrained to an emission bandwidth below the bandwidth of the visible spectrum and has a broad bandwidth, then architectures exist that can combine tunable emission pixels with different ranges to give good gamut coverage and offer the ability to optimize across the metrics earlier specified. For example, referring to FIG. 2, a first tunable emitter may have a tuning range 210 covering 400-510 nm and a second tunable emitter may have a tuning range 220 covering 510-700 nm. Thus, the two emitters can have two sets of peaks 201, 202 and 204, 205, selected with chromaticities such that their connecting lines 203 and 206, respectively, intersect the target color and then by adjusting the power of the emitters to hit the target 210. Thus, as shown, an example color (white) may be produced by a range of wavelength pairs. These metamers may have considerably different properties, for example the 490 nm-600 nm pair will have a much higher m/p ratio than the 425 nm-575 nm pair.

In one embodiment, one of the tunable light emitters is tunable at least in the range of 540 to 620 nm, or 530 to 630 nm, or 520 to 640 nm, and the other one of the tunable light emitters is tunable at least in the range of 440 to 490 nm, 430 to 500 nm, or 420 to 510 nm. In this embodiment, the two tunable light emitters form a pixel.

In one embodiment, at least one tunable light emitter comprising a plurality of tunable light emitters, each of the two tunable light emitters emitting a tunable peak having limited range—e.g., a range of less than 50 nm, or 40 nm, or 30 nm. In such an embodiment, a plurality of light emitters may be used. In one embodiment, the plurality of tunable light emitters comprises three tunable light emitters. In one embodiment, the three tunable light emitters comprise a tunable blue emitter, a tunable cyan or green emitter, and a tunable red emitter. In one embodiment, the tunable blue emitter is tunable in the range of at least 440 to 460 nm, 430 to 470 nm, or 420 to 475 nm, the tunable cyan/green emitter is tunable in the range of at least 510 to 530 nm, 505 to 540 nm, or 500 to 550 nm, and the tunable red emitter is tunable in the range of at least 600 to 620 nm, 590 to 630 nm, or 500 to 630 nm. In such an embodiment, the three tunable light emitters form a pixel.

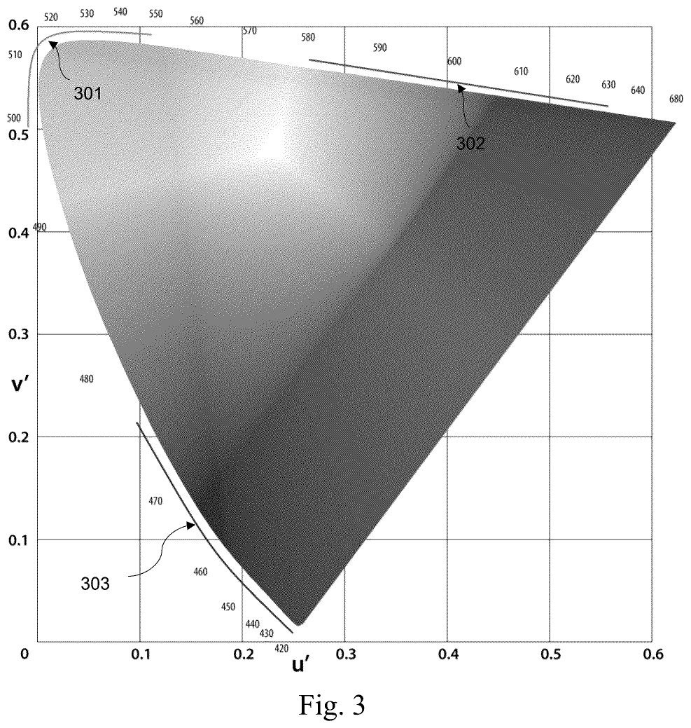

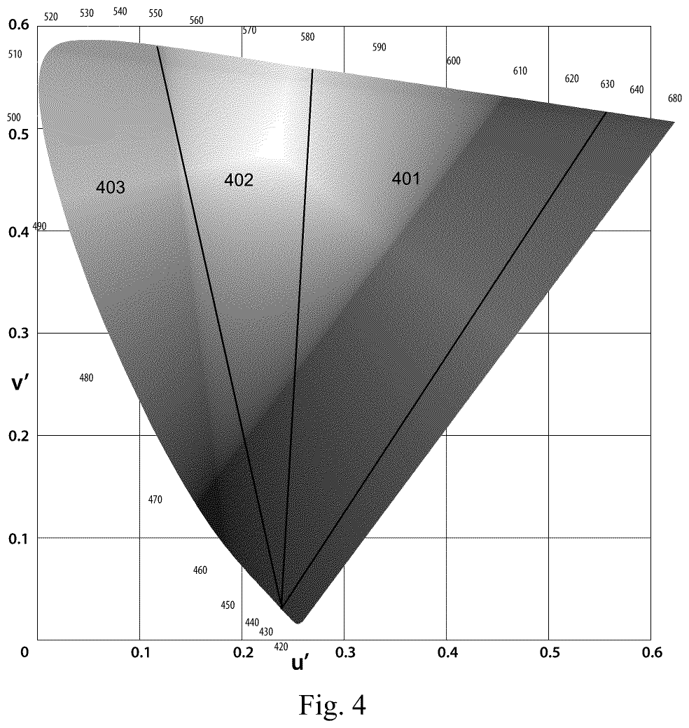

One embodiment of a plurality of tunable light emitters having relatively narrow bands is shown in FIG. 3. In this embodiment, the light emitters comprise a red emitter 302, having a tunable range of 580-630 nm, a green emitter 301 having a tunable range of 500-550 nm, and a blue emitter 303 having a tunable range of 425-475 nm. This configuration allows for good gamut coverage and for metameric variation. Although this may not be an optimal solution, it is simple. For example, referring to FIG. 4, in low EML mode, the gamut may be divided in the following way: (1) region 401: fixed blue at 425 nm, red varies across full range, ratio of emissions adjusted to reach target color, green off; (2) region 402 fixed blue at 425 nm, fixed ‘red’ at 580 nm, fixed green at 550 nm. (colors reached by ratio of emissions); (3) 403 fixed blue at 425 nm, green varies across range, colors reached by ratio of emissions.

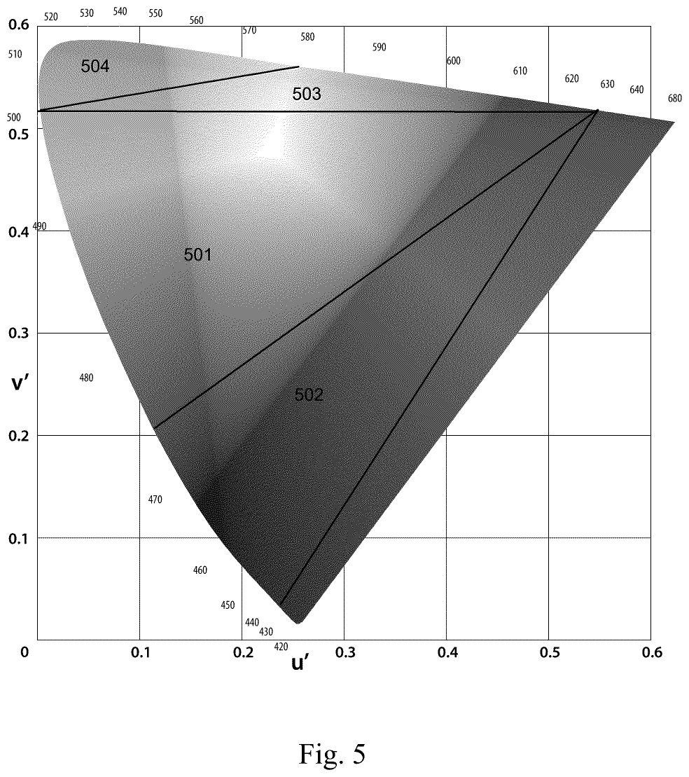

Referring to FIG. 5, in high EML mode, the gamut may be divided in the following way: (1) region 501: Blue at 475 nm, green at 500 nm, red at 630 nm (colors achieved through ratio of emissions); (2) region 502: Blue full range, red fixed at 630 nm, green off (colors achieved through ratio of emissions); (3) region 503: Green at 500 nm, red full range, blue off; and (4) Region 504: Red at 580, green full range (although mostly 500-520 nm), blue off.

Although the description above address display in particular the concepts apply to general lighting as well. Embodiments include devices capable of emitting with a selectable peak wavelength and approximately gaussian emission profile in the visible range. An arbitrary number of peak wavelengths and associated intensities may be selected at any given time. This allows for the production spectra with a high degree of flexibility. For example, high CRI light of any CCT may be selected. Light maybe optimized to have the best possible CRI, while meeting a blue percentage threshold, either above or below, and being at a chosen CCT.

These devices have high resolution in small form factors. For example, 720p in a ¼ inch package. At this same spatial resolution, a 3030 package could contain 300 by 300 individually controllable, spectrally tunable sources. In addition to spectral tunability, this would allow for beam shaping by coupling of the spatial location on the emitter with optics with different properties. For example, this approach supports a circadian downlight where the day mode is wide, intense, and blue rich, while the night mode is narrow, dim, and blue depleted.

These and other advantages maybe realized in accordance with the specific embodiments described as Well as other variations. It is to be understood that the above description is intended to be illustrative, and not restrictive. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled.

What is claimed is:

1. A display comprising:
a plurality of pixels, each pixel comprising at least one tunable light emitter to emit tuned light in at least two modes, a low equivalent melanopic lux (EML) mode and a high EML mode, wherein said tuned light in either said low EML mode or said high EML mode spans substantially the visible light range; and
circuitry to drive said at least one tunable light emitter in said at least two modes.

2. The display of claim 1, wherein said tuned light in said high EML mode and said tuned light in said low EML mode are metameric spectrums.

3. The display of claim 1, wherein said at least one tunable light emitter comprising just one tunable light emitter configured to emit a configurable spectrum.

4. The display of claim 3, wherein said just one tunable light emitter emits two peaks, each of said two peaks being tunable.

5. The display of claim 4, wherein said two peaks are tunable over at least a substantial portion of the visible light spectrum.

6. The display of claim 5, wherein said substantial portion of the visible light spectrum is from 440 to 630 nm, or from 420 to 640 nm, or from 400 to 700 nm.

7. The display of claim 3, wherein said just one tunable light emitter is a pixel.

8. The display of claim 1, wherein said at least one tunable light emitter comprising two tunable light emitters, each of said two tunable light emitters emitting a tunable peak.

9. The display of claim 8, wherein each tunable peak is tunable over at least a substantial portion of the visible light spectrum.

10. The display of claim 9, wherein said substantial portion of the visible light spectrum is from 440 to 630 nm, or from 420 to 640 nm, or from 400 to 700 nm.

11. The display of claim 8, wherein each of said tunable light emitter is tunable over different portions of the visible light spectrum.

12. The display of claim 11, wherein one of said tunable light emitters is tunable at least in the range of 540 to 620 nm, or 530 to 630 nm, or 520 to 640 nm, and the other one of said tunable light emitters is tunable at least in the range of 440 to 490 nm, 430 to 500 nm, or 420 to 510 nm.

13. The display of claim 8, wherein said two tunable light emitters forms a pixel.

14. The display of claim 1, wherein said at least one tunable light emitter comprising a plurality of tunable light emitters, each of said two tunable light emitters emitting a tunable peak having a range of less than 50 nm, or 40 nm, or 30 nm.

15. The display of claim 14, wherein said plurality of tunable light emitters comprises three tunable light emitters.

16. The display of claim 15, wherein said three tunable light emitters comprise a tunable blue emitter, a tunable cyan emitter, and a tunable red emitter.

17. The display of claim 16, wherein said tunable blue emitter is tunable in the range of at least 440 to 460 nm, 430 to 470 nm, or 420 to 475 nm, said tunable cyan emitter is tunable in the range of at least 510 to 530 nm, 505 to 540 nm, or 500 to 550 nm, and said tunable red emitter is tunable in the range of at least 600 to 620 nm, 590 to 630 nm, or 500 to 630 nm.

18. The display of claim 15, wherein said three of said tunable light emitters forms a pixel.

19. The display of claim 1, wherein said tuned light in said high EML mode and said tuned light in said low EML mode have an EML ratio of no less than 2:1, or 3:1, or 4:1 or 5:1, or 6:1, or 7:1, or 8:1, or 9:1, or 10:1.

20. The display of claim 19, wherein said tuned light in said low EML mode has an EML no greater than 180, or no greater than 170, or no greater than 160, or no greater than 150.
